(19) United States
(12) Patent Application Publication
(10) Pub. No.: US 2007/0124384 A1
(43) Pub. Date: May 31, 2007

(54) Voicemail and fax filtering

(75) Inventors: David A. Howell, Seattle, WA (US); Srinivasa R. Manda, Sammamish, WA (US); Clifford N. Didcock, Sammamish, WA (US); Sridhar Sundararaman, Bellevue, WA (US); Roy Williams, Woodinville, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/283,192

(22) Filed: Nov. 18, 2005

(51) Int. Cl. G06F 15/16

(52) U.S. Cl. 709/206

(57) ABSTRACT

The subject innovation pertains to filtration of voice, facsimile and the like communications. These messages can be analyzed to determine if they are unsolicited bulk communications (i.e., spam) or include malicious code. Analysis or filtration can be accomplished by, among other things, transforming the message into an email. The email can include the message as an attachment and a body that provides at least a portion of the content. Conventional and novel analysis tools can subsequently be applied to the email to scan for spam and viruses, among other things.

### BACKGROUND

The Internet has spawned many new communications mediums that continue to become increasingly popular and wide spread. These new mediums include but are not limited to electronic mail (email) and text messaging over a network of two or more computers or network connectable, processor-based devices. Email allows electronic communication of a text message alone or in combination with graphics and optional attachments. Text or instant messaging is a simpler communication mechanism for transmitting short text messages. These electronic communication mediums are popular as they provide cheap, easy, point-to-point communication that is less intrusive than a traditional phone call. There is an abundance of other benefits, for example, email easily enables one-to-many communication, there is no need to synchronize participants and the content can be planned easier, among other things. Unfortunately, these mediums have two main adversaries that threaten the convenience of and confidence in their use, namely spam and viruses.

Spam is the electronic relative of traditional junk mail. Like junk mail, spam is unsolicited messages that are sent in bulk. Typically, spam is commercial in nature. For example, direct marketers, companies, and individuals employ spam to advertise products, get-rich-quick schemes and the like as well as solicit donations. Due to the nature of spam, that is unwanted messages, and the pure volume thereof, spam is a nuisance that inconveniences users of electronic communication mediums Not only do users have to waste time sorting through a deluge of undesired communications, but also they likely bear the cost (passed on by service providers) of the tremendous amounts of resources (e.g., storage space, network bandwidth . . . ) required to cope with these messages. Furthermore, a large volume of spam can have the effect of a denial of service attack, because the real mail is lost in the mass of other messages.

In addition to spam, electronic communication systems are susceptible to virus and other types of malicious code such as worms and Trojans. For instance, a message such as an email can include a virus as an attachment. A computer can subsequently be infected with the virus upon execution, for example, upon opening the attachment. The virus can then damage hardware, software, and/or files. The virus can thereafter be transferred and spread to other computers via email. A worm is similar to a virus in its devastating effects but can replicate and transmit itself to other computers without aid. For example, a worm can locate a user's address book and send itself to every listed recipient. A Trojan or Trojan horse is slightly different in that it employs trickery to lure a user to open or execute the code and does not infect files like a virus or replicate itself like a worm. Rather, a Trojan appears as a legitimate piece of software that when opened can delete or destroy files as well as open a backdoor that can be utilized to access personal or confidential information and/or hijack a computer.

A variety of systems and techniques have been developed and employed to combat spam and malicious code. More specifically, email and text messages are subject to numerous filters to detect spam and/or malicious code. Once identified, action is taken on the content such as redirection to a designated location (e.g., spam folder, quarantine region . . . ) and/or deletion, among other things.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described the subject innovation provides for filtering voice, fax and like communications. In particular, filters or agents can be executed that detect unsolicited bulk communications or spam and/or malicious code such as viruses, worms, and Trojans, among others.

In accordance with an aspect of the subject innovation, filtering of voice and facsimile communications can be accomplished by leveraging the existing email pipeline and associated processes. Such communications can be converted into emails or SMTP messages of a particular form to align the messages with standard analysis tools. More particularly, voice and fax messages can be analyzed and at least a portion of the content provided in the body of an email as a preview together with other type-specific MIME data. The emails can then be processed utilizing conventional email filters.

According to another aspect of the subject innovation, preview generation can be done utilizing native or plug-in speech-to-text algorithms or mechanisms for voice messages. Similarly, native or plug-in character recognition techniques can be employed with respect to scanned documents such as facsimiles.

According to still another aspect of the subject innovation, the voice, fax or like communication can be added to an email as an attachment. Special filters are then able to analyze the entire message rather than just the generated preview. Furthermore, such filters can provide additional information that may be of interest in detecting spam, for instance, such as tone of voice or volume.

In accordance with a particular aspect of the subject innovation, a branch exchange component can forward a telephone call to a conversion component that answers the call and generates an email message. The generated message is then transmitted to a message server (e.g., SMTP server, email server) that applies one or more filters thereon to detect, among other things, spam and/or malicious code.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a system that facilitates detection of spam and/or malicious code.

FIG. 2 is a block diagram of an exemplary detection component.

FIG. 3 is a block diagram of a voice/facsimile filtration system.

FIG. 4 is a block diagram of a voice/facsimile message system.

FIG. 5 is a block diagram of an exemplary conversion component.

FIG. 6 is a block diagram of a message filtration system.

FIG. 7 is a block diagram of a conversion component.

FIG. 8 is a block diagram of a message filtration system.

FIGS. 9a-b depict exemplary message content that may be transmitted to recipients in conjunction with voice or facsimile communications.

FIG. 10 is a flow chart diagram of a communication preprocessing methodology.

FIG. 11 is a flow chart diagram of a message processing methodology.

FIG. 12 is a flow chart diagram of a composition methodology associated with an audio or voice communication.

FIG. 13 is a flow chart diagram of a composition methodology associated with a facsimile communication.

FIG. 14 is a flow chart diagram of a message server method.

FIG. 15 is a flow chart diagram of a client application method.

FIG. 16 is a schematic block diagram illustrating a suitable operating environment for aspects of the subject innovation.

FIG. 17 is a schematic block diagram of a sample-computing environment.

### DETAILED DESCRIPTION

The various aspects of the subject innovation are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

As used in this application, the terms “component” and “system” and the like are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

Artificial intelligence based systems (e.g., explicitly and/or implicitly trained classifiers) can be employed in connection with performing inference and/or probabilistic determinations and/or statistical-based determinations as in accordance with one or more aspects of the subject innovation as described hereinafter. As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject innovation.

Furthermore, the present invention may be implemented as a method, apparatus, or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

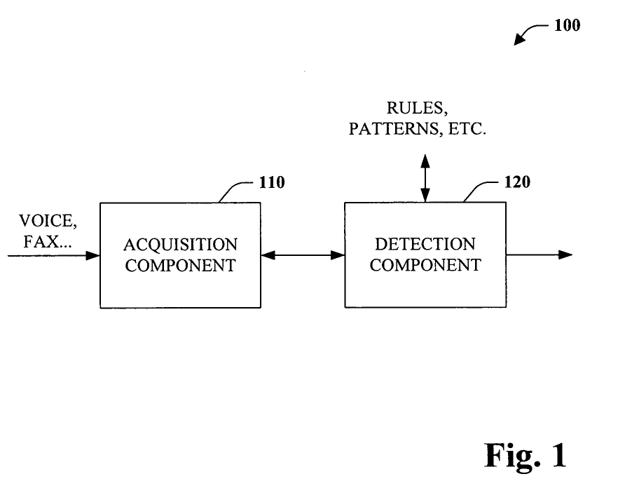

Turning initially to FIG. 1, a voice/fax message system 100 is disclosed to identify unsolicited bulk messages and/or malicious code. System 100 includes an acquisition component 110 and a detection component 120. The acquisition component 110 receives, retrieves, or otherwise obtains or acquires voice or facsimile messages or the like. The acquisition component 110 is communicatively coupled to detection component 120. Accordingly, the acquisition component 110 can transmit a message to detection component 120. Alternatively, the detection component 120 can retrieve the message from the acquisition component 110 or operate on the message as it is obtained (e.g., real time, streaming . . . ). The detection component 120 can analyze a message and determine or identify unsolicited bulk messages or spam and/or malicious code including but not limited to viruses, worms, and Trojans. Detection can be accomplished based on one or more rules or algorithms, preferences, pattern matching, and/or machine learning or artificial intelligence among other things. For example, spam can be detected utilizing an algorithm that checks for particular keywords or phrases. Based on the results of the algorithm a score can be assigned that corresponds to the likelihood that a message is spam. If the score is greater than or equal to a particular value (e.g., predefined) spam can be said to have been detected. If the score is less than the particular number, spam has not been found. Upon detection of spam, various characteristics can be noted to improve the detection mechanism with respect to future messages. By way of example and not limitation, the origination phone number or other identifier can be logged in the expectation that future message from this number are more likely to be spam or include malicious messages. Similar mechanisms and methodologies can be applied to facilitate identification of malicious code.

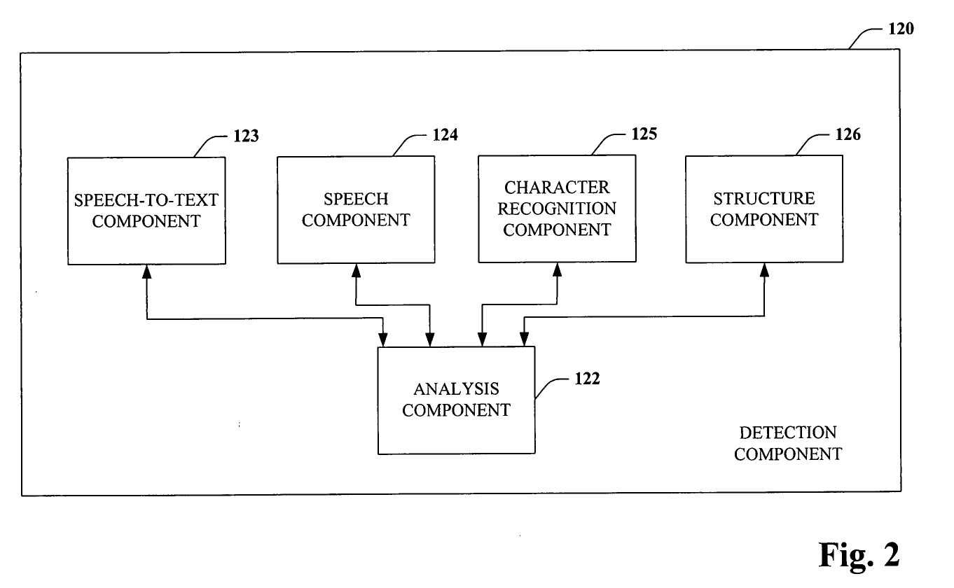

FIG. 2 illustrates the detection component 120 in further detail in accordance with an aspect of the subject innovation. The detection component 120 includes analysis component 122. The analysis component 122 is communicatively coupled to speech-to-text component 123, speech component 124, character recognition component 125 and structure component 126. As a result, the analysis component 122 can utilize input provided or received from one or more of the communicatively coupled components 123, 124, 125 and 126 to facilitate detection of spam and/or malicious code, inter alia.

The speech-to-text component (also referred to herein as STT component) 123 recognizes verbal communication and converts spoken or recorded words to text. Hence, the STT component 123 can convert a voice message substantially in real time as it is being communicated or from a recorded version thereof. In this manner, the analysis component 122 can scrutinize the text produced by STT component 123 to detect spam or malicious code.

In contrast to the STT component 123, the speech component 124 can scan the audio alone, rather than text produced there from, to facilitate identification of particular keywords, phrases, and/or patterns thereof. Hence, the analysis component 122 can provide keywords, for example, to the speech component 124 and the component can indicated whether such keywords are present in the audio. Additionally, the speech component 124 may be able to discern additional characteristics that may be of interest including but not limited to tone of voice and volume.

The analyzer component 122 can also employ the character recognition component 125 to aid in identifying particular words in an electronic communication such as a fax. For example, the recognition component 125 can employ standard and/or novel recognition algorithms to create a structured document that represents the content of a scanned document. Additionally or alternatively, the structure component 126 is operable to scan the structure of a document, such as a fax, rather than the converted structured document to facilitate detection of spam or malicious code.

It should be appreciated that the analysis component 122 can employ more than one of the described components to facilitate detection as well as improve reliability. By way of example and not limitation, the analysis component 122 can receive data from both the STT component 123 and the speech component 124 to determine whether particular words or phrases are present in a voice message. Likewise, character recognition component 125 and structure component 126 can be utilized in combination to aid in identifying spam and/or malicious code in a scanned document such as a facsimile.

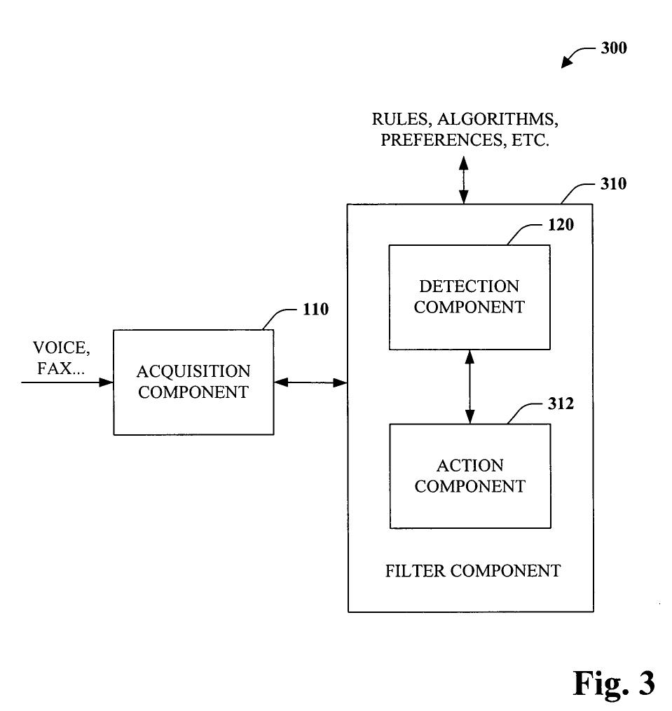

FIG. 3 depicts a message filtration system 300 in accordance with an aspect of the claimed innovation. The filtration system 300 includes an acquisition component 110 and a filter component 310. The acquisition component 110 receives, retrieves or otherwise obtains or acquires an electronic voice or fax communication. The acquisition component 110 is communicatively coupled to the filter component 310. The filter component 310 filters out, removes, or otherwise acts upon communications that are determined to be spam or include malicious code, among other things. The determination and action performed upon identification of such messages can be guided by algorithms, rules and/or preferences. The filter component 310 includes detection component 120 and action component 310.

The detection component 120, as previously described with respect of FIGS. 1 and 2, is operable to identify communications that are likely to be spam or contain malicious code based at least in part upon the content of the voice or facsimile message. For instance, the detection component 120 can analyze a voice message for keywords, phrases or patterns by analyzing the audio alone and/or by converting the audio to text and scrutinizing the text. Similarly, the detection component 120 can identify particular keywords or phrases in a scanned document such as a facsimile by evaluating the structure of the document and/or converting the document to a structured document (e.g., including tags, metadata, XML . . . ), for example, utilizing character recognition mechanisms and/or methods. The detection component 120 is communicatively coupled to the action component 312.

The action component 312 receives indication of whether a message is spam or includes malicious code from the detection component 120. Upon receipt of such an indicator, the action component 312 can perform some action, for instance based upon one or more rules and/or preferences. By way of example, upon receipt of a message that is identified as spam, the action component 312 could forward the message to a junk mail container or simply delete the message. Similarly, upon receipt of a message including malicious code the message could be deleted or quarantined so as not to allow the code to achieve its intended result. Additionally or alternatively, the phone number or other identifier of the source of a message can be recorded. Action taken by the action component 312 can be performed by a user application (e.g., email application) or more sensibly by a mail server such as an SMTP (Simple Mail Transport Protocol) server to relieve the user application of such responsibility. Likewise, detection can also be executed by a user application or a mail server.

It should also be appreciated that filter component 310 need not only be employed with respect to spam and malicious code. Additionally, the filter component 310 could represent some user or administrator rules or preferences. The filter component 310 could then be utilized to group or organize particular types of messages based at least upon their content. Thus, the detection component 120 could be employed to identify particular content and the action component 312 could perform the act or acts required to group or organize a message in accordance with a rule.

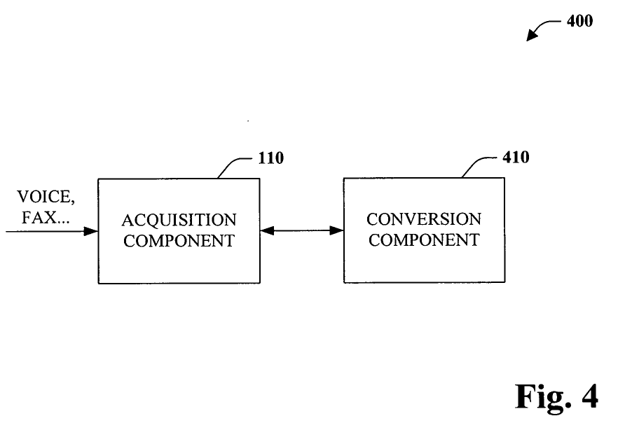

Referring to FIG. 4, a voice/facsimile message system 400 is disclosed in accordance with an aspect of the innovation. The system 400 includes acquisition component 110 and conversion component 410. The acquisition component 110, as previously described can receive, retrieve, or otherwise obtain or acquire a voice or facsimile communication. The acquisition component 110 is communicatively coupled to the conversion component 410. Conversion component 410 receives, retrieves or otherwise obtains a communication from the acquisition component 110. Upon receipt or retrieval, the conversion component 410 can convert the voice or facsimile message into an electronic message or email. For example, a voice communication can be recorded and added to the email as an attachment. Furthermore, at least a portion of the content of the message can be provided within the body of the email.

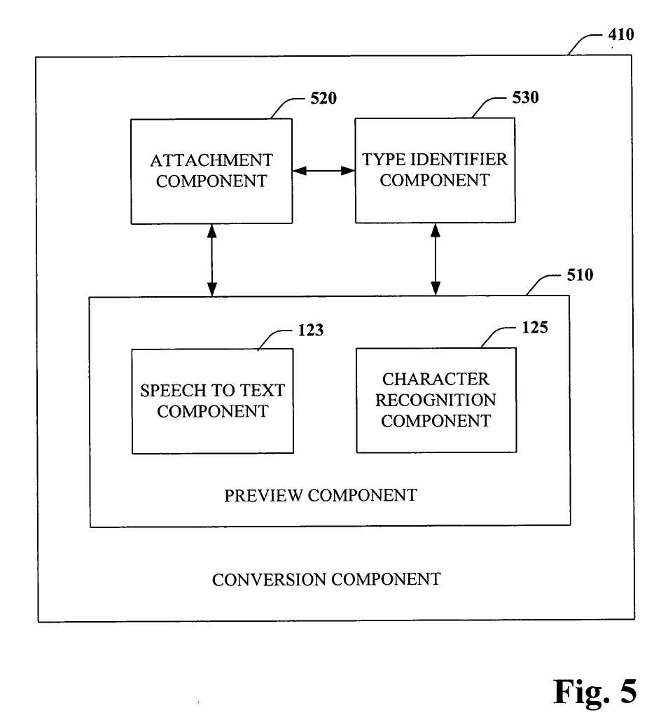

Turning attention to FIG. 5, the conversion component 410 is illustrated in accordance with an aspect of the claimed innovation. The conversion component 410 includes a preview component 510. The preview component 510 enables at least a portion of the content of a voice or facsimile message to be provided in the body of an email. The preview component 510 includes speech-to-text (STT) component 123 and character recognition component 125. The STT component 123 can recognize a voice and translate the words into text utilizing standard and/or novel algorithms. The character recognition component 125 can analyze a scanned document, such as a fax, and identify and organize the characters therein. The functionality provided by components 123 and 125 can be executed in real time during receipt of the message (e.g., recording thereof) or after on the recorded or saved version. The words and/or characters provided by STT component 123 or character recognition component 125 can be inserted into the body of the email associated with the message by preview component 510.

Conversion component 410 can also include an attachment component 520. The attachment component 520 can record and/or save a received voice or facsimile message. The recorded or saved version of the message can then be added to the email as an attachment. Conversion component 410 is communicatively coupled to preview component to facilitate generation of a preview of the message as detailed supra.

In addition to the aforementioned components, the conversion component 410 can include a type identity component 530. The identity component 530 can provide an indication in the email as to whether includes a voice mail message or a facsimile message. This indication can also be provided in the email body, inter alia. To aid the determination of voice or fax message, the identifier component is communicatively coupled to the preview component 510 and the attachment component 520. The identifier component 520 can make such a determination for example based on the attachment itself or whether the STT component 123 or the character recognition component 125 is employed to generate a preview and/or the preview itself.

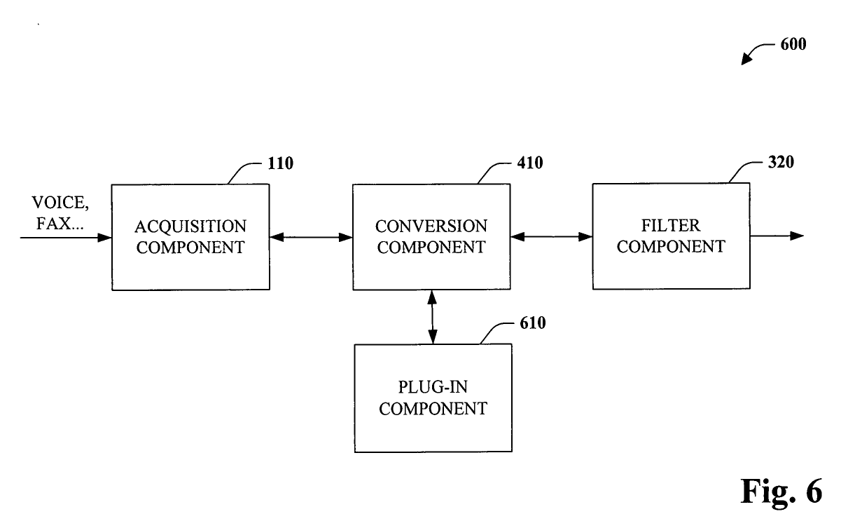

FIG. 6 illustrates a message filtration system 600. Filtration system 600 includes an acquisition component 110. As described supra, acquisition component 110 can receive, retrieve or otherwise obtain or acquire voice and/or facsimile messages. The acquisition component 110 provides message data to the communicatively coupled conversion component 410.

The conversion component 410 converts a voice or facsimile message to an email message. For example, the voice or fax can be recorded or saved and attached to the email and at least a portion of the content provided in the body, among other things. The conversion component 410 can be communicatively coupled to one or more non-native, plug-in components 610 thereby extending the functionality of the conversion component 410. For example, plug-in component 610 can provide speech-to-text functionality to the conversion component 410.

Filter component 320 is communicatively coupled to and can receive messages from conversion component 410. The filter component 320 can identify and act upon particular emails. For instance, the filter component 320 can scan the text of converted voice or fax message for particular keywords and perform some action if the keywords are found. Additionally or alternatively, the filter component 320 can scan the attachment, which may include an audio or a scanned document, among other things. It should be appreciated that the filter component 320 can be combined with the conversion component 410.

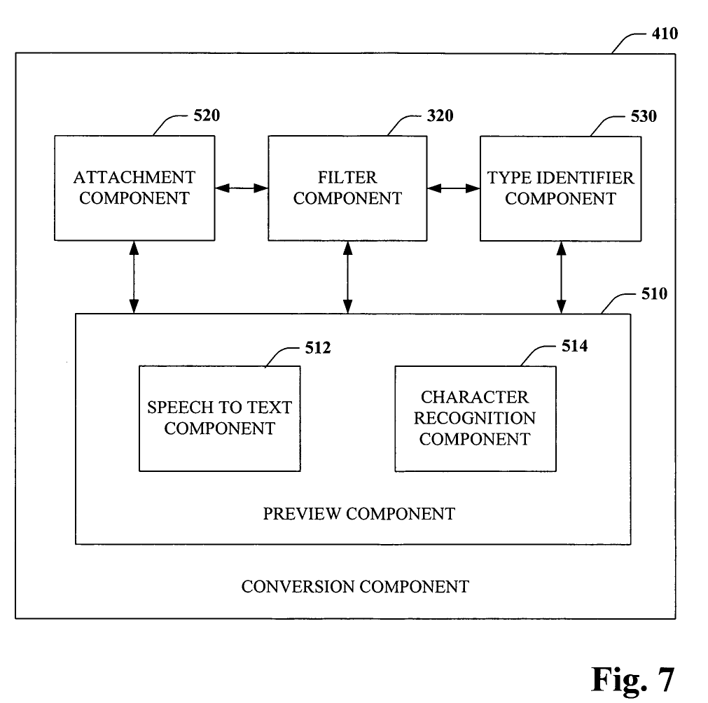

Turning to FIG. 7, a conversion component 410 is illustrated in accordance with an aspect of the subject innovation. The conversion component 410 includes preview component 510, attachment component 520, type identifier component 530 and filter component 320. The preview component 510 includes a speech-to-text (STT) component 512 and character recognition component 514. The preview component 510 can interact with the attachment component 520, in one scenario, and provide at least a portion of the content within the body of an email. The STT component 512 can convert speech to text. Accordingly, the STT component 512 can be employed to convert a voice message to text characters. The character recognition component 514 can discover and capture characters in a document. Thus, the character recognition component 514 can be utilized to capture the content of a scanned document such as a facsimile. The attachment component 520 generates a file from a voice or fax communication that is later added to an email as an attachment. The type identifier component 530 generates an identifier for addition to an email that signifies the type of the email message. For example, the identifier could denote that the email corresponds to a message that captures a voice or facsimile message. The conversion component 410 can also include the filter component 320.

Filter 320 is communicatively coupled to the attachment component 520, the preview component 510 and the type identifier component 530. The filter component 320 can spot particular keywords, phrases or the like in an attempt to detect particular message content including but not limited to unsolicited bulk messages and malicious code. Action can be initiated by the filter component 320 based on the content discovered. The filter component 320 can analyzed a voice message during or after recording via the attachment component 520. Additionally or alternatively, the content preview generated by preview component 510 may be analyzed by the filter component 320 to detect and/or act upon messages. The filter component 320 may also provide information to the type identifier component 530 to facilitate discovery of the type of email message.

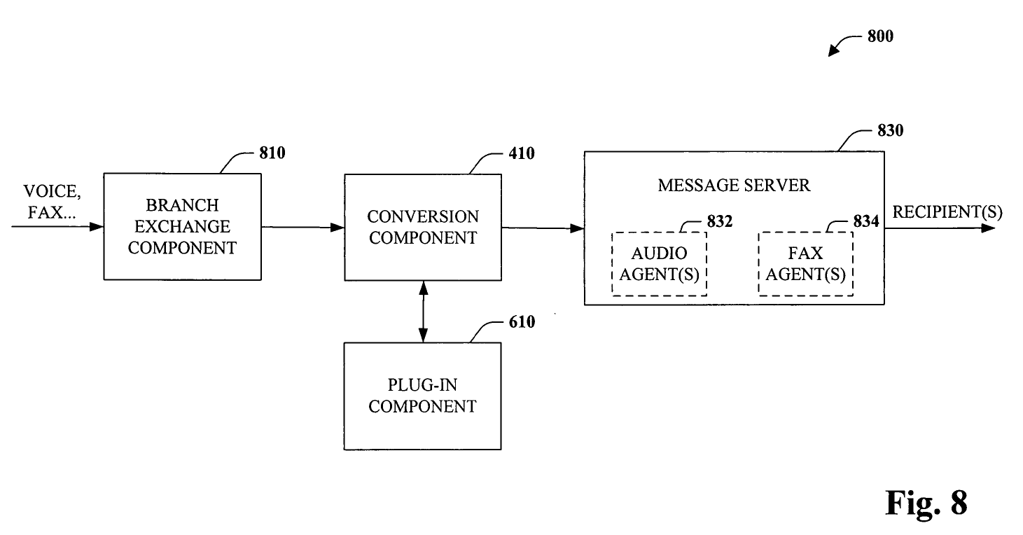

FIG. 8 illustrates an exemplary message filtration system 800 in accordance with an aspect of the subject innovation. Filtration system 800 includes a branch exchange component 810 that acquires voice and/or facsimile communications. The branch exchange component 810 can include a traditional or Intranet protocol (IP) branch exchange (IPBX). Furthermore, the exchange component 810 can be public (e.g., central office exchange service) or private (PBX). The exchange component 810 can receive communications from conventional telephone systems or over the Internet, among others, via a telephone protocol, IP protocol (e.g., H.323, SIP . . . ) or any other public or proprietary protocol. Upon receipt of a communication the branch exchange component 810 can route the communication to the conversion component 820. By way of example, the branch component 810 can forward a call that was not answered or a phone number configured to answer a fax to the component 410.

Conversion component 410, as previously described, can convert a received communication to an email. The conversion component 410 can receive a communication from the branch exchange component 810 or via a connection provided thereby. The communication can subsequently or concurrently be transformed into an SMTP (Simple Mail Transfer Protocol) message. As discussed supra, a voice or facsimile message can be recorded or saved and provided as an attachment. Further, at least a portion of the content of the message can be encoded in the body, for instance in a MIME (Multipurpose Internet Mail Extension) format. Additional information can also be captured in the body including but not limited to message type (e.g. voice, fax), calling telephone number, voice message duration, voice message sender name, attachment name, and fax number of pages. Further yet, the MIME message could be converted into an internal representation, which could be stored with an internal representation of a message classification. This classification can then be used by client access software to display an optimized UI.

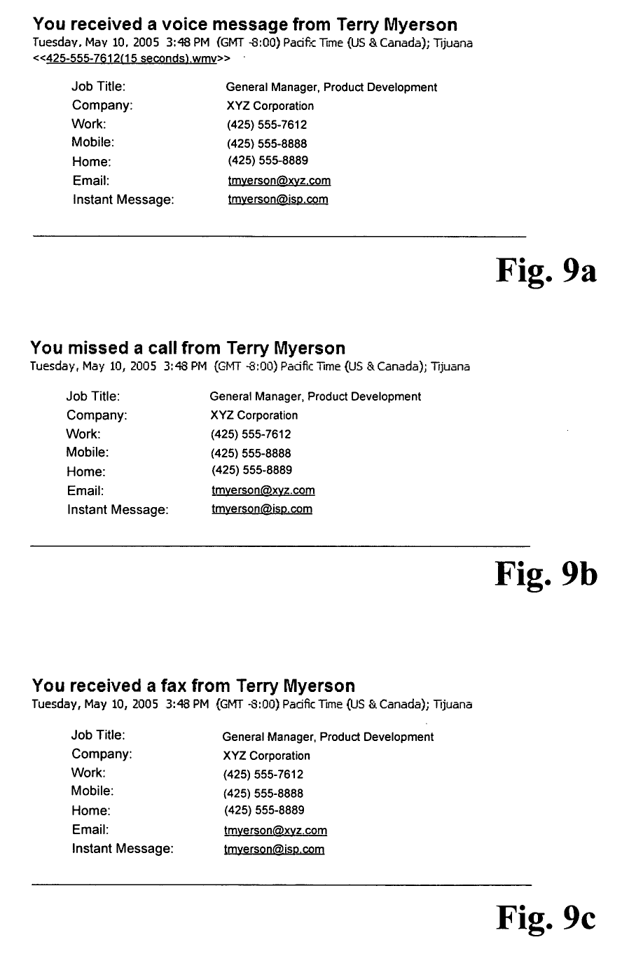

Still further yet, based on available information from the branch exchange 810 and/or message server 830, the conversion component 410 can compose viewable messages, for instance utilizing the HTML content type. By way of example and not limitation FIGS. 9a-c are provided. As will be appreciated by those of skill in the art, the following sample illustrations are only one of numerous manners of providing information to recipients. Further, additional and/or alternate content can be provided thereby. FIG. 9a illustrates sample voicemail message content when caller id is resolved. As shown, it is indicated that a voice message was received from a sender on a particular date. The attached message is saved as a WMA (Windows Media Audio) file named “425-555-7512” that is 15 seconds in duration. Furthermore, information regarding the sender including his job title, company, work number, mobile number, home number, as well as his email and instant message address is provided. FIG. 9b provides a sample missed call message content when caller id is resolved. Here, similar information is presented, but there is no attached file perhaps because a sender decided not to leave a message. Finally, FIG. 9c depicts sample facsimile message content when the caller id is resolved. In this scenario, the same information is provided but directed toward a facsimile message.

Conversion component 410 is also extensible. In particular, the conversion component 410 can utilize third party and/or non-native functionality, for instance provided by plug-in component 610. By way of example and not limitation, the plug-in component 610 can provide one or more algorithms to facilitate translating speech-to-text or for optical character recognition. In this manner, not all functionality needs to be provided solely by the conversion component 410. Moreover, the conversion component 410 can be updated such that it can employ the best techniques or mechanisms associated with email generation.

It should also be noted that conversion component 410 may facilitate checking intended recipients mailbox quota prior to and/or after receiving the message. In this manner, the component 410 can ensure a message that is accepted is transmitted to the intended recipient, as senders expect this and are often unable to receive a report indicating that the message was not delivered. For example, the system 820 may not answer a call indicated for a recipient whose mailbox quota has been exceeded.

A generated email or SMTP message can be transmitted from the conversion component 410 to a message server 830 (also a component as defined herein). The message server 830 can process messages for delivery to an intended recipient mailbox(es), among other things, such that they can be received or retrieved by an email application (e.g., viewer/editor and POP or IMAP client). Accordingly, the server 830 may correspond to among other things a mailbox, SMTP and/or a bridgehead server. It should also be appreciated that the conversion component 410 can be an SMTP client that communicates with the SMTP server. In addition to forwarding messages to a recipient's mailbox or mailboxes, the message server 830 can filter such messages. The filtration can be done using conventional filters for email including spam and malicious code filters or agents as well as normal email rules or agents. In this manner, the general message delivery pipeline can be leveraged to perform voice/fax filtering without the need to build a new pipeline. Additionally, the message server 830 can employ one or more special agents 832 (also components as that term is defined herein) to scan the audio rather than the text preview of the message. Such audio agents 832 could filter based on tone of voice, volume, and/or obscenity checking, among other things. Similarly, special fax agents 834 (also components as that term is defined herein) can be utilized to scan the structure of the email separate from the converted structured document or preview. It should also be noted that these agents 832 and 834 can be plug-ins or add-ons produced by the server vendor or third-party vendors, among others.

It should be noted that conversion component 410 might select from more than one message server 830. The component 410 may select from a list of servers utilizing an algorithm such as a round-robin algorithm to select a server during message submission. If component 410 fails to contact the selected server, it can note this and utilize the next server. The server marked as down will not be utilized for a predetermined time period (e.g., N seconds). If no server is available, the call will not be answered or a prompt can be played indicating that the server is unavailable. If the server goes down after answering the call and recording the message, then the conversion component 410 and more specifically a spooler associated therewith can ensure that the message is delivered when a server comes online.

The aforementioned systems have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

Furthermore, as will be appreciated, various portions of the disclosed systems above and methods below may include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, filter component 810 and or agents 832 and 834 can utilize such mechanisms or methodologies to facilitate analyzing message content. The component 810 or agents 832 and 834 can infer (as that term is defined herein) that a message contains spam and/or malicious code based on the current message content as well as previous experience or knowledge.

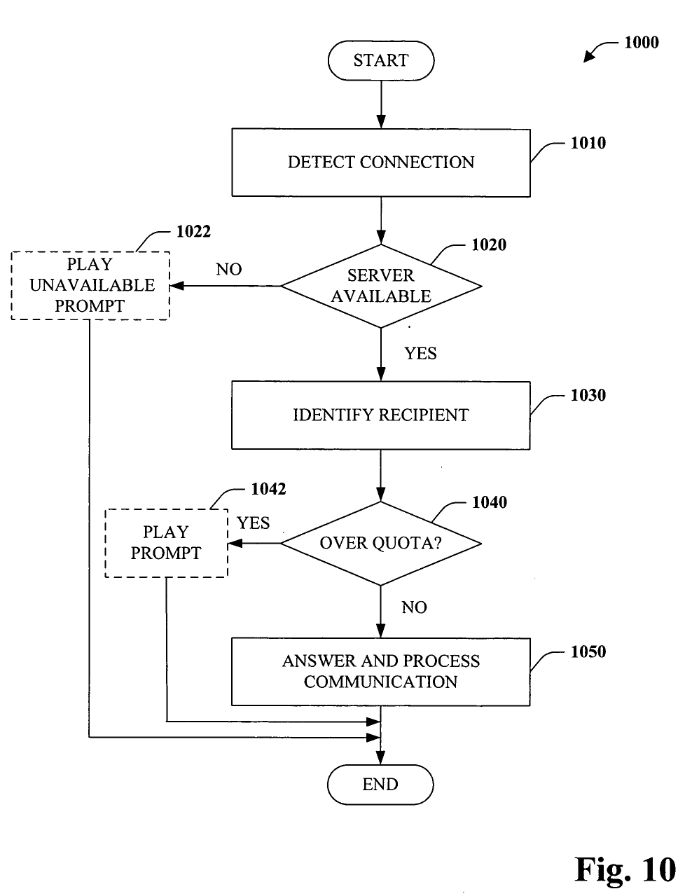

In view of the exemplary systems described supra, methodologies that may be implemented in accordance with the disclosed subject matter will be better appreciated with reference to the flow charts of FIGS. 10-15. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Turning to FIG. 10, a preprocessing methodology 1000 is depicted in accordance with an aspect of the subject innovation. Prior to accepting and processing a communication such as a voice message several acts can be performed. This preprocessing is done to accommodate user expectations that when a voice or fax message is sent and received such message reaches the intended recipient. Unlike email, such methods often do not provide a means to receive a report indicating that the intended recipient did not receive the message. At reference numeral 1010, a connection is detected. For example, an incoming call or communication is forwarded from a branch exchange or other acquisition component. At 1020, a determination is made as whether a server such as a bridgehead is available to accept the message. If no, the communication can be answered and a prompt provided to the effect that the server is unavailable, at 1022. The method can subsequently terminate. However, it should also be noted that the communication might simply not be accepted. For example, a telephone communication may be allowed to continue ringing with out answer. Either way, a communication is not received that may not be delivered to its intended recipient. If a server is available, at 1020, then the method can continue at 1030 where an intended recipient is identified. For example, based on a telephone number dialed the intended recipient can be looked up or otherwise identified. At reference numeral 1040, a determination is made as to whether the intended recipient's mailbox is over quota. A quota may be associated with the mailbox by an administrator to limit the number of message a user can receive. If the mailbox is over quota, at 1042, the communication can be answered and a message played that indicates that the mailbox is full. Alternatively, the communication can simply go unanswered. It should be noted that there can be a benefit in not answering such as the PBX or other exchange component may have logic to pass the call to another end point in this case. If the mailbox is not over quota, then the method can proceed to 1050 where the communication is answered and processed. Subsequently, the method terminates. It should be appreciated that the server may become unavailable while the communication is being processed. In this case, the processed communication can be placed in a queue and send when the server becomes available. Similarly, an intended recipient's mailbox quota may be filled during processing. In this special scenario, the quota may be exceeded and the message delivered.

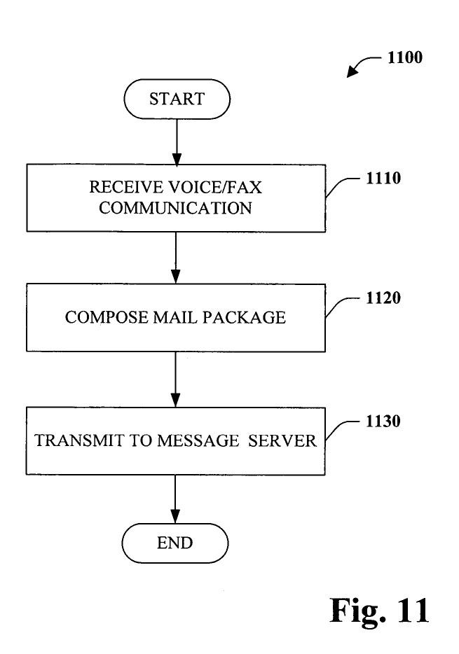

FIG. 11 depicts a message processing methodology 1100 in accordance with an aspect of the subject invention. At reference numeral 1110, a voice or facsimile communication or message is received. At 1120, an email or mail package is generated based on the communication received. The email or mail package can subsequently be transmitted to a message server or the like at 1130 to be delivered to the mailbox of the intended recipient. For example, such transmission may be made utilizing SMTP.

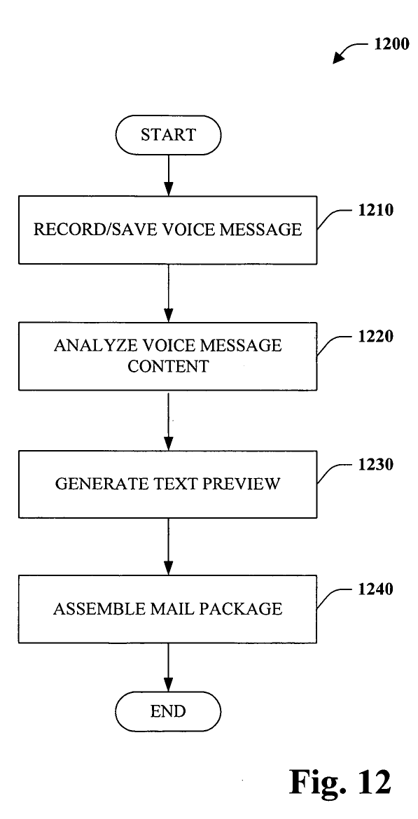

FIG. 12 illustrates a composition methodology 1200 associated with an audio or a voice message. At 1210, a voice communication is saved or recorded. The voice communication content can be analyzed during or after recording at numeral 1220. At 1230, a preview of the communication is generated. The preview includes text of at least a portion of the audio communication. For example, speech-to-text mechanisms and/or techniques can be employed to convert the audio to text for the preview. At 1230, a message package or email is generated. The saved audio can be provided as an attachment and the preview can form part of the body of the email. It should also be noted that MIME headers might be populated such as message type, calling telephone number, recipient email address(es), voice message duration, voice message sender name, subject, and attachment name (empty for missed call). It should also be appreciated that the “sender” MIME header is different from the standard “from” MIME to account for individuals utilizing others phones, computers, and the like. It may also be specified whether non-delivery reports are desired where appropriate and whether the caller tagged the message as important, among other things. It should also be noted that the email composed might correspond to a missed call (e.g., see FIG. 9b) if the caller fails to leave a message, for instance.

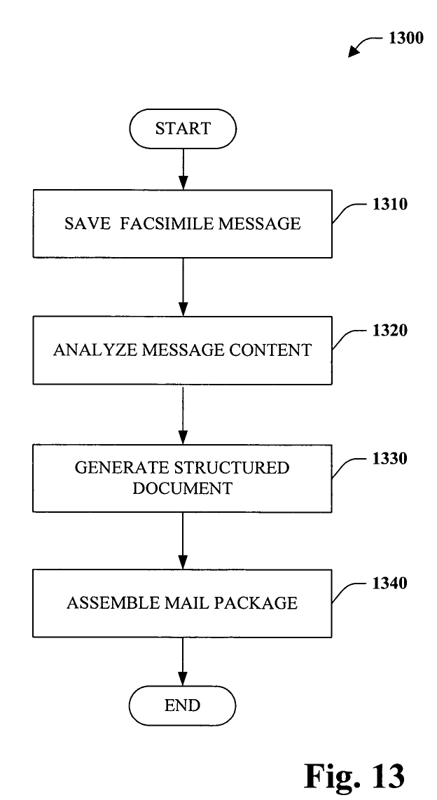

FIG. 13 depicts a method of communication 1300 processing associated with a facsimile message. At reference numeral 1310, a received facsimile, or like scanned document, is saved. The content of the facsimile is analyzed at 1320. This act can be performed subsequent to or concurrently with saving. At 1330, a structured document, or preview, is created that captures at least a portion of the content of the fax. This can correspond to applying character recognition techniques or mechanisms to the document. At 1340, an email or other mail package is assembled. In particular, the saved facsimile can be added as an attachment and the preview can be added to the body of the email. It should also be appreciated that MIME headers can be set such as the message type (here fax), the calling telephone number, and the number of pages of the fax, among other things.

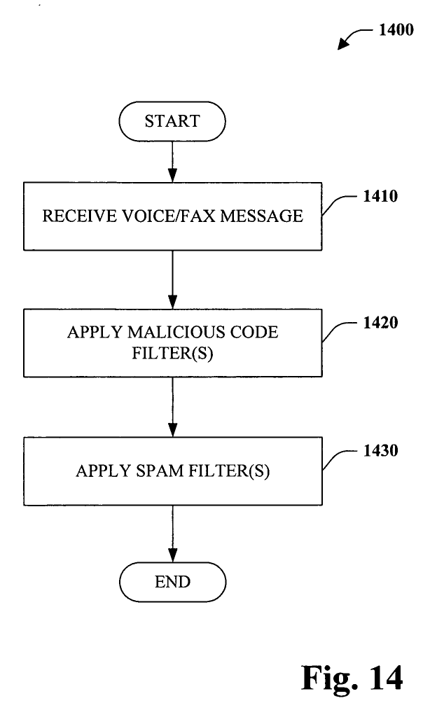

FIG. 14 illustrates a message server methodology 1400 in accordance with an aspect of the subject innovation. At reference numeral 1410, an email message is received for a voice and or fax message. As previously described, the email can include a voice or fax message as an attachment as well as a preview thereof in the body of the email. At 1420, one or more malicious code filters are applied to the email. The filters may include those standard filters that analyze all emails. In particular, such filters may catch malicious code such as viruses, worms, or Trojans in the preview provided in the body. However, additional filters can be applied to the voice or fax message specifically. At 1430, one or more spam filters can be applied to the email. Again, such filters may be standard filters that are applied to all email. Spam can be detected based on the preview provided in the body of the email in this scenario. Additionally or alternatively, special filters can be applied to the voice or fax message attachment specifically. These filters can enable detection of additional characteristics that may be of interest in detecting spam including but not limited to the tone of voice and volume of an email and the structure of a facsimile message.

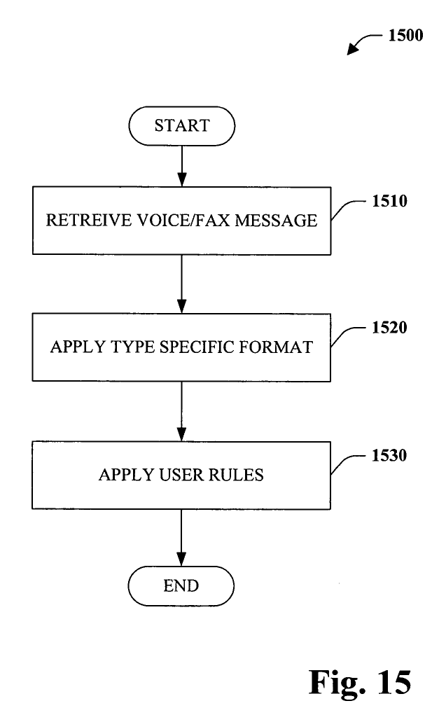

Turning to FIG. 15, a flow chart diagram is provided that illustrates a client application method 1500 in accordance with an aspect of the subject innovation. At reference numeral 1510, a voice/fax email message is received. Such message can be received from a message server, for instance, utilizing POP or IMAP protocols. At 1520, type specific format is applied to a specific message. For example, the MIME format is interpreted and messages are displayed in accordance therewith. FIGS. 9a-9b provide exemplary display formats for voice and fax messages. At 1530, specific rules are user defined rules are applied to the messages. For example, messages from a particular sender or telephone number can be moved to a designated folder or trigger an alarm. Additionally, it should be appreciated that any other acts that can be applied to conventional emails or that are associated with standard email programs can be applied with respect to voice/fax messages.

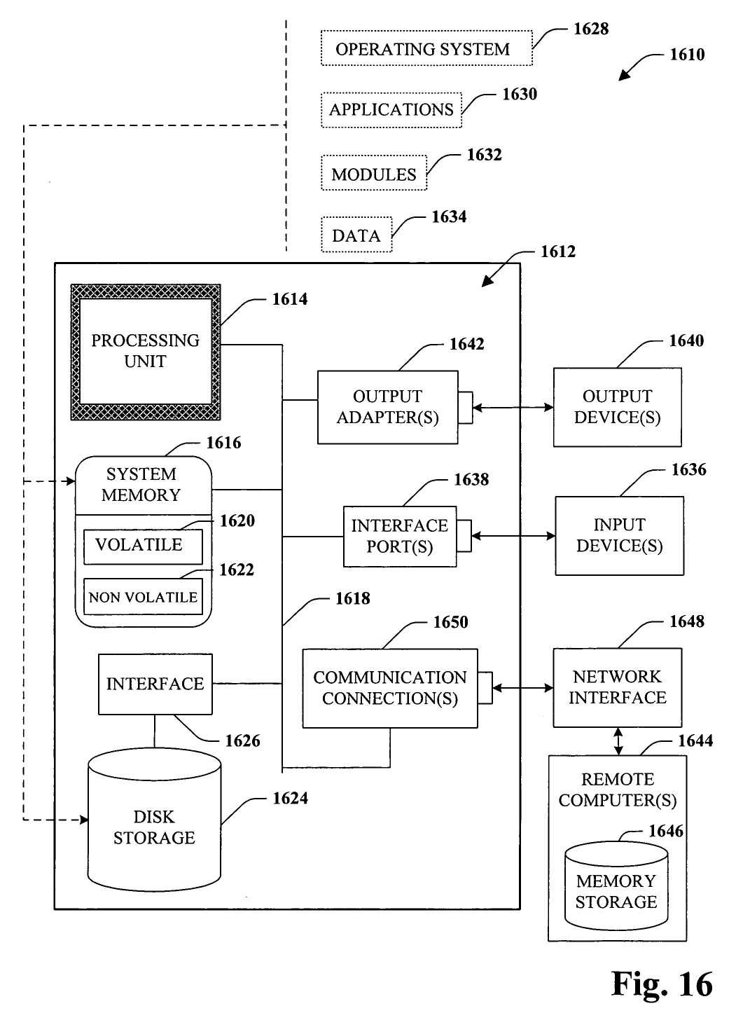

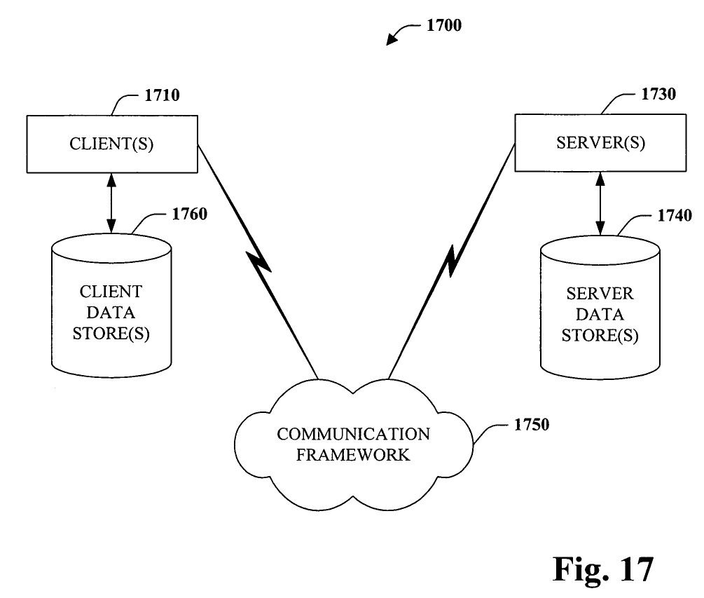

In order to provide a context for the various aspects of the disclosed subject matter, FIGS. 16 and 17 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed innovation can be practiced on stand-alone computers. In a distributed computing environment, program modules may be located in both local and remote memory storage devices.

With reference to FIG. 16, an exemplary environment 1610 for implementing various aspects disclosed herein includes a computer 1612 (e.g., desktop, laptop, server, hand held, programmable consumer or industrial electronics . . . ). The computer 1612 includes a processing unit 1614, a system memory 1616, and a system bus 1618. The system bus 1618 couples system components including, but not limited to, the system memory 1616 to the processing unit 1614. The processing unit 1614 can be any of various available microprocessors. Dual microprocessors and other multiprocessor architectures also can be employed as the processing unit 1614.

The system bus 1618 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1616 includes volatile memory 1620 and nonvolatile memory 1622. The basic input/output system (BIOS), containing the basic routines to transfer information between elements within the computer 1612, such as during start-up, is stored in nonvolatile memory 1622. By way of illustration, and not limitation, nonvolatile memory 1622 can include read only memory (ROM), programmable ROM (PROM), electrically programmable ROM (EPROM), electrically erasable ROM (EEPROM), or flash memory. Volatile memory 1620 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1612 also includes removable/non-removable, volatile/non-volatile computer storage media. FIG. 16 illustrates, for example, disk storage 1624. Disk storage 1624 includes, but is not limited to, devices like a magnetic disk drive, floppy disk drive, tape drive, Jaz drive, Zip drive, LS-100 drive, flash memory card, or memory stick. In addition, disk storage 1624 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1624 to the system bus 1618, a removable or non-removable interface is typically used such as interface 1626.

It is to be appreciated that FIG. 16 describes software that acts as an intermediary between users and the basic computer resources described in suitable operating environment 1610. Such software includes an operating system 1628. Operating system 1628, which can be stored on disk storage 1624, acts to control and allocate resources of the computer system 1612. System applications 1630 take advantage of the management of resources by operating system 1628 through program modules 1632 and program data 1634 stored either in system memory 1616 or on disk storage 1624. It is to be appreciated that the present invention can be implemented with various operating systems or combinations of operating systems.

A user enters commands or information into the computer 1612 through input device(s) 1636. Input devices 1636 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1614 through the system bus 1618 via interface port(s) 1638. Interface port(s) 1638 include, for example, a serial port, a parallel port, a game port, and a universal serial bus (USB). Output device(s) 1640 use some of the same type of ports as input device(s) 1636. Thus, for example, a USB port may be used to provide input to computer 1612 and to output information from computer 1612 to an output device 1640. Output adapter 1642 is provided to illustrate that there are some output devices 1640 like displays (e.g., flat panel and CRT), speakers, and printers, among other output devices 1640 that require special adapters. The output adapters 1642 include, by way of illustration and not limitation, video and sound cards that provide a means of connection between the output device 1640 and the system bus 1618. It should be noted that other devices and/or systems of devices provide both input and output capabilities such as remote computer(s) 1644.

Computer 1612 can operate in a networked environment using logical connections to one or more remote computers, such as remote computer(s) 1644. The remote computer(s) 1644 can be a personal computer, a server, a router, a network PC, a workstation, a microprocessor based appliance, a peer device or other common network node and the like, and typically includes many or all of the elements described relative to computer 1612. For purposes of brevity, only a memory storage device 1646 is illustrated with remote computer(s) 1644. Remote computer(s) 1644 is logically connected to computer 1612 through a network interface 1648 and then physically connected via communication connection 1650. Network interface 1648 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit-switching networks like Integrated Services Digital Networks (ISDN) and variations thereon, packet switching networks, and Digital Subscriber Lines (DSL).

Communication connection(s) 1650 refers to the hardware/software employed to connect the network interface 1648 to the bus 1618. While communication connection 1650 is shown for illustrative clarity inside computer 1616, it can also be external to computer 1612. The hardware/software necessary for connection to the network interface 1648 includes, for exemplary purposes only, internal and external technologies such as, modems including regular telephone grade modems, cable modems, power modems and DSL modems, ISDN adapters, and Ethernet cards or components.

FIG. 17 is a schematic block diagram of a sample-computing environment 1700 with which the subject innovation can interact. The system 1700 includes one or more client(s) 1710. The client(s) 1710 can be hardware and/or software (e.g., threads, processes, computing devices). The system 1700 also includes one or more server(s) 1730. Thus, system 1300 can correspond to a two-tier client server model or a multi-tier model (e.g., client, middle tier server, data server), amongst other models. The server(s) 1730 can also be hardware and/or software (e.g., threads, processes, computing devices). The servers 1730 can house threads to perform transformations by employing the subject innovation, for example. One possible communication between a client 1710 and a server 1730 may be in the form of a data packet transmitted between two or more computer processes. For instance, a data packet can correspond to an email communication associated with a voice or fax communication, among other things.

The system 1700 includes a communication framework 1750 that can be employed to facilitate communications between the client(s) 1710 (e.g., email applications) and the server(s) 1730 (e.g., message, STMP, bridgehead . . . ). The client(s) 1710 are operatively connected to one or more client data store(s) 1760 that can be employed to store information local to the client(s) 1710. Similarly, the server(s) 1730 are operatively connected to one or more server data store(s) 1740 that can be employed to store information local to the servers 1730.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” or variations thereof are used in either the detailed description or the claims, such terms are intended to be inclusive in a manner similar to the term “comprising” as “comprising” is interpreted when employed as a transitional word in a claim.

What is claimed is:

1. A computer implemented filtration system comprising the following computer implemented components:
an acquisition component that receives a voice or fax communication; and
a detection component that detects unsolicited bulk communications.

2. The system of claim 1, further comprising an action component that acts upon a detected unsolicited bulk communication in accordance with a rule.

3. The system of claim 1, the detection component detects one or more viruses associated with the communication.

4. The system of claim 3, the detection component includes an analysis component that analyzes data from one or more of a speech-to-text component, a speech component, a character recognition component and a structure component.

5. The system of claim 1, further comprising a conversion component that generates an email including the communication as an attachment.

6. The system of claim 5, the conversion component includes a preview component that provides a portion of the communication content in text in the email body to facilitate detection of unsolicited bulk communications.

7. The system of claim 5, the conversion component includes a type identifier component that identifies the type of message as at least one of voice and facsimile.

8. The system of claim 5, the conversion component interacts with a plug-in component that provides functions to the detection component to facilitate detection of unsolicited bulk communications.

9. The system of claim 1, the communication is received from a branch exchange.

10. A method of interacting with voice and fax messages comprising the following computer implemented acts:
receiving an electronic transmission of a voice or facsimile message; and
generating an email that includes the voice or facsimile message as an attachment and at least a portion of the content of the message captured in the body.

11. The method of claim 10, generating the email comprises capturing the content in MIME format.

12. The method of claim 10, generating the email comprises employing one or more of speech-to-text and character recognition mechanisms or methodologies to the message to capture the at least a portion of the content of the message.

13. The method of claim 10, further comprising providing the email to a mail server.

14. The method of claim 10, further comprising employing a plug-in component to facilitate electronic mail generation.

15. The method of claim 10, receiving the electronic transmission comprises receiving a call forwarded by a branch exchange.

16. The method of claim 10, further comprises analyzing the message to determine if the message is spam or includes a virus.

17. The method of claim 16, analyzing the message comprises identifying one or more keywords in the body of the email.

18. A mail server method comprising the following computer executable acts:
receiving an email comprising a voice mail or facsimile message as an attachment and a body including at least of portion of the content of the message; and
determining whether the email is an unsolicited bulk communication.

19. The method of claim 18, determining whether the message is an unsolicited bulk communication comprises applying a spam filter to one of the body of the email and the attachment.

20. The method of claim 19, further comprising forwarding the email to a mailbox of a recipient, if the email is not an unsolicited bulk communication.
